(19) United States
(12) Patent Application Publication
(10) Pub. No.: US 2026/0278249 A1
(43) Pub. Date: Sep. 17, 2026

(54) ARTIFICIAL INTELLIGENCE-BASED GENERATION OF APPLICATION STATE KEYS FOR CONTENT STREAMING SYSTEMS AND APPLICATION

(71) Applicant: NVIDIA Corporation, Santa Clara, CA (US)

(72) Inventors: Anjul Patney, Redmond, WA (US); Ambrish Dantrey, San Jose, CA (US); Jason Mawdsley, San Jose, CA (US); Deep Shekhar, Bangalore (IN); Ram Rangan, Chennai (IN)

(21) Appl. No.: 19/089,628

(22) Filed: Mar. 25, 2025

(30) Foreign Application Priority Data
Mar. 17, 2025 (IN) 202511023713

(51) Int. Cl. G06F 40/166; A63F 13/67; G06F 9/451; G06V 10/25; G06V 10/70; G06V 30/14; G06V 30/19

(52) U.S. Cl. CPC G06F 40/166; A63F 13/67; G06V 10/25; G06V 10/70; G06V 30/1448; G06V 30/191; G06F 9/453

(57) ABSTRACT

In various examples, generative artificial intelligence (AI) models may be used to automatically generate state keys (or “identifiers”) associated with an interactive application. For instance, the systems and methods of the present disclosure may use the AI models to generate the state keys corresponding to essential features of an application. The generated state keys may be structured as key-value pairs, enabling automated application state tracking by mapping values of the essential features to their respective state identifier keys during application runtime. In some examples, the systems and methods of the present disclosure may generate the state keys in a number of ways, such as by using a pretrained AI model with intrinsic knowledge of the application, using a generic AI model to infer the essential features by analyzing a plurality of screenshots captured during application runtime and/or by processing application documentation, wikis, or manuals.

### CROSS-REFERENCE TO RELATED APPLICATIONS

This application claims priority to Indian Patent Application number 202511023713, filed Mar. 17, 2025, which has hereby incorporated by reference in its entirety.

### BACKGROUND

Intelligent virtual assistants may be integrated into a variety of interactive applications to provide context-aware support and enhance user experience. For instance, virtual assistants may be integrated into various applications across a number of domains, including, but not limited to, gaming applications, design software, productivity tools, and/or enterprise applications. Typically, these virtual assistants may offer relevant guidance, constructive feedback, automate workflows, and/or enhance user productivity by extracting key contextual information associated with the application, which may include user actions, interface elements, resource availability, and/or other relevant parameters. In some cases, this information may be obtained through direct integration with the application itself (e.g., via application programming interfaces (APIs)). Additionally, or alternatively, external methods-such as computer vision or text recognition—may be used to infer application states.

However, developing virtual assistants for interactive applications can present significant challenges due to the need for comprehensive understanding of the application. For instance, to provide meaningful assistance, a virtual assistant- or the models it relies on—may require sufficient contextual information about the application to accurately interpret user queries and generate appropriate responses. Additionally, identifying which aspects of an application should be tracked may be difficult, as different applications may emphasize distinct types of data, interface components, and/or operational parameters. As such, this process often requires developers or domain experts to manually analyze application behavior, review documentation, and determine relevant application features through extensive experimentation. Thus, scaling virtual assistants across a wide variety of applications may require substantial effort and customization.

### SUMMARY

Embodiments of the present disclosure relate to artificial intelligence (AI)-based generation of application state keys for content streaming systems and application. Systems and methods are disclosed that may use generative AI models to automatically generate state keys (also referred to herein as state “identifiers”) associated with an interactive application. For instance, the systems and methods of the present disclosure may use the AI models to generate state keys corresponding to essential features of an application (e.g., an interactive application, such as a gaming application, image editing application, video editing application, productivity application, etc.). The generated state keys may be structured as key-value pairs, enabling automated application state tracking by mapping values of the essential features to their respective state identifier keys during application runtime. In some examples, the systems and methods of the present disclosure may generate the state keys in a number of ways. For instance, the state keys may be generated using an AI model that is pretrained with respect to an application and has intrinsic knowledge of the application. Additionally, or alternatively, the state keys may be generated using an AI model (e.g., a generic AI model) to infer the essential features of the application by analyzing a plurality of screenshots captured during application runtime and/or by processing application-related documentation, wikis, manuals, or other Retrieval-Augmented Generation (RAG) sources.

In contrast to conventional systems, the systems of the present disclosure, in some embodiments, may provide an AI-driven approach to automatically generating application state keys, significantly reducing the need for manual intervention. By leveraging generative AI models, the disclosed systems and methods may dynamically infer and structure essential state keys without requiring extensive domain expertise, thereby enabling broader applicability across diverse interactive applications. Additionally, in contrast to conventional systems, the disclosed systems and methods may enhance adaptability by incorporating multimodal AI capabilities, including computer vision and document analysis, to extract relevant state information from various sources such as application interfaces, user interactions, and/or associated documentation. The disclosed systems and methods may also reduce development overhead and accelerate deployment by eliminating the need for manual feature engineering, making virtual assistants more scalable across different applications.

### BRIEF DESCRIPTION OF THE DRAWINGS

The present systems and methods for artificial intelligence-based generation of application state keys for content streaming systems and application are described in detail below with reference to the attached drawing figures, wherein:

FIG. 1 is a data flow diagram illustrating an example of a process for automatically generating and using application state keys for indicating application state, in accordance with some embodiments of the present disclosure;

FIG. 2 illustrates an example of application features that may correspond to application state keys generated using the systems and methods of the present disclosure, in accordance with some embodiments of the present disclosure;

FIG. 3A illustrates an example of using one or more pretrained models with intrinsic knowledge of an application to automatically generate application state keys, in accordance with some embodiments of the present disclosure;

FIG. 3B illustrates an example of using one or more models (e.g., generic models) to automatically generate application state keys based at least on processing input data that includes information (e.g., documentation, wikis, etc.) associated with an application, in accordance with some embodiments of the present disclosure;

FIG. 3C illustrates an example of using one or more models (e.g., generic models) to automatically generate application state keys based at least on processing input data that includes image data associated with an application, in accordance with some embodiments of the present disclosure;

FIG. 4 illustrates an example of using values associated with application state keys to respond to a user query associated with a gaming application, in accordance with some embodiments of the present disclosure;

FIG. 5 illustrates another example of using values associated with application state keys to respond to a user query associated with an interactive application, in accordance with some embodiments of the present disclosure;

FIG. 6 is a block diagram illustrating an example of a system for performing one or more of the processes or methods described herein, in accordance with some embodiments of the present disclosure;

FIG. 7 is a flow diagram illustrating an example of a method for automatically generating a data structure(s) for tracking application state, in accordance with some embodiments of the present disclosure;

FIG. 8 is a flow diagram illustrating an example of a method for mapping values to application state keys generated using the automated, AI-based techniques described herein, in accordance with some embodiments of the present disclosure;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram illustrating an example of a content streaming system suitable for use in implementing some embodiments of the present disclosure;

FIG. 11 is a block diagram of an example computing device suitable for use in implementing at least some embodiments of the present disclosure; and

FIG. 12 is a block diagram of an example data center suitable for use in implementing at least some embodiments of the present disclosure.

### DETAILED DESCRIPTION

Systems and methods are disclosed related to artificial intelligence (AI)-based generation of application state keys for content streaming systems and application. For instance, the systems and methods of the present disclosure may use AI models to generate state keys (also referred to herein as “state identifiers”) corresponding to features (e.g., essential features) of an application (e.g., an interactive application, such as a gaming application, image editing application, video editing application, productivity application, etc.). The generated state keys may be structured as key-value pairs, enabling tracking of application states by mapping values of the features to their respective state identifier keys during application runtime. In some examples, the systems and methods of the present disclosure may generate the state keys in a number of ways. For instance, the state keys may be generated using an AI model that is pretrained with respect to an application and has intrinsic knowledge of the application. Additionally, or alternatively, the state keys may be generated using an AI model (e.g., a generic AI model) to infer the essential features of the application by analyzing a plurality of screenshots captured during application runtime and/or by processing application-related documentation, wikis, manuals, or other Retrieval-Augmented Generation (RAG) sources.

By way of example, and not limitation, a system(s) may, in accordance with one or more embodiments of the present disclosure, apply input data to one or more models that are configured to—or capable of—automatically generate one or more application state keys (or “identifiers”) corresponding to one or more features of an application (e.g., an interactive application). As described herein, in some examples, the content or substance of the input data may vary based on a variety of factors, such as the type of model(s) being used, the level of training or intrinsic knowledge the model(s) has with respect to the application, the amount of application-related information that is available for input, the type of application-related information that is available, and/or any other factors.

For example, in some instances, the model(s) may include one or more “pretrained” models that have intrinsic knowledge of the application. That is, the pretrained model(s) may have knowledge of the essential features of the application that contribute to the application's state. In such examples, the input data may simply include text data representing a prompt(s) that is applied to the pretrained model(s). For instance, the prompt(s) may request the model(s) to generate a structured list of application state keys that best characterize the current state of the application and/or the current state of the application's features. The model(s) may use its prior training to infer the most relevant features and output a set of predefined keys corresponding to those features. For gaming applications, for instance, the model(s) may generate state keys such as player health, player location, player action(s), inventory status, current quest objectives, enemy positions, or any other state keys. As another example, for productivity applications the model(s) may identify active tool selections, document status, and/or recent user actions as state identifiers.

Additionally, or alternatively, in some instances the model(s) may include one or more “generic” models that lack or otherwise have limited intrinsic knowledge of the application. In other words, in contrast to the pretrained model(s) that may have knowledge of the application and understand the application's essential features, the generic model(s) may, in some instances, be unaware of the application itself, what the application is used for, what kind of application it is, and/or what its essential features might include. That is, the generic model(s) may process and use external sources of information to infer the key features of an application. For instance, the model(s) may analyze external data sources, such as visual or textual information related to the application, to extract patterns and determine which features are essential for tracking the application's state.

In such examples, the input dataset to the model(s) (e.g., the generic model(s)) may include image data representing a number of screenshots captured during application runtime. For instance, a set of diverse images from an interactive application may be applied as input(s) to the model(s), and the model(s) may process the set of images and extract key visual elements from the images and determine the state keys. In a gaming application, for example, the model(s) may detect elements such as player statistics, remaining time in a mission, or a minimap, and subsequently generate corresponding state keys like “Player_Health,” “Time_Remaining,” or “Player_Location,” respectively. Similarly, for a design application, the model may detect, for instance, things like toolbar selections, layer structures, or active editing modes to generate state keys such as “Active_Tool,” “Layer_Selection,” or “Undo_History,” respectively.

Additionally, or alternatively, the input dataset may include text data and/or image data obtained from various types of information sources related to the application, such as application documentation, application manuals, wiki pages related to the application, and/or any other types of application-related information. In such examples, the input dataset may be applied to the model(s) as part of a Retrieval Augmentation Generation (RAG) dataset, enabling the model(s) to cross-reference information from structured documentation that may relate to the application. For instance, the model(s) may process this information/inputs and extract relevant state-related terminology, determine relationships between different application features, determine which features of the application should be tracked for conveying the applications' state, and construct a comprehensive list of state keys. For instance, in the case of a gaming application, the model(s) may process a game wiki (or data representing or corresponding to the game wiki) and identify key gameplay mechanics such as crafting, skill trees, or combat attributes, and translate them into state keys such as “Crafting_Materials,” “Skill Points,” or “Weapon_Equipped,” respectively.

In some examples, the model(s) described herein—including the “pretrained” model(s) and the “generic” model(s)—may include one or more language models. However, although many of the examples herein are described with respect to using language models, and, specifically, multimodal language models (MMLMs), this is not intended to be limiting. For example, and without limitation, any of the various model(s) described herein may include any type of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-trained (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian Splat models, models with encoder-only architectures, models with decoder-only architectures, models with encoder-decoder architectures, generative machine learning models, large language models (LLMs), small language models (SLMs), vision language models (VLMs), multimodal language models (MMLMs), including multimodal LLMs and/or multimodal SLMs, and/or any other types of machine learning or generative AI models.

In some examples, the model(s) described herein may be packaged as a microservice—such as an inference microservice (e.g., NVIDIA NIMs)—which may include a container (e.g., an operating system (OS)-level virtualization package) that may include an “engine.” For example, the inference microservice may include the container itself and the model(s) (e.g., weights and biases). In some instances, such as where the model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

In some instances, the model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

As described herein, in some examples, the system(s) may use the model(s) to determine the feature(s) (e.g., essential features) of the application, as well as to generate the state keys to be used for tracking one or more states associated with the feature(s) and/or the application. In some examples, the feature(s) may include one or more attributes (e.g., user-related attributes, environment-related attributes, tool-related attributes, progress indicators, etc.) of the application that dynamically change during runtime and are relevant for indicating the application's state and providing contextual responses. For instance, in a gaming application, the feature(s) may include, but are not limited to, player-related attributes (e.g., health, stamina, inventory, equipped weapon, current location, experience points), game environment attributes (e.g., level name, current objective, active non-player characters (NPCs), time remaining in a mission, weather conditions), and/or other gameplay-related information (e.g., score, active buffs or debuffs, recent in-game actions). As another example, in an image or video editing application, the feature(s) may include, but are not limited to, currently active tool(s) (e.g., brush, selection tool, color picker), layer information (e.g., number of layers, active layer, visibility settings), document properties (e.g., resolution, color mode, aspect ratio), and/or applied effects (e.g., filters, blending modes, adjustments).

In some examples, the system(s) may use the model(s) to determine methods for populating values corresponding to the state keys (e.g., key-value pairs). For instance, the system(s) may use the model(s) to identify one or more bounding regions within an application's interface (e.g., on-screen interface) that contain relevant state information. The bounding regions may be used (e.g., analyzed) to dynamically extract values during application runtime using optical character recognition (OCR) models and/or object detection techniques. For example, in a gaming application, the model(s) may determine that a mini map is always located in the top-right corner of the screen and provide this spatial information as part of the output data structure. During gameplay, a secondary vision model may then analyze the identified region to extract relevant data, such as the player's location coordinates and/or enemy locations.

Additionally, in some instances, the system(s) may use the model(s) to generate code (e.g., computer-executable instructions) for automating the extraction of state values. For instance, an AI-based code generation model may produce executable scripts (e.g., in Python or C++) to capture and process relevant state data in real time. These scripts may encapsulate function calls to OCR libraries, image segmentation tools, or direct API hooks into an application's internal data structures, thereby streamlining the integration of state tracking into various applications. For instance, the model(s) may generate code that, when executed by downstream components or models, causes the components or models to analyze a certain bounding region within an image frame (e.g., screenshot) captured during application runtime and map the values obtained from that bounding region to a certain set of one or more state keys/identifiers. As an example, in a racing game, the standings of a current race may be indicated in a corner of the screen, and the code may instruct the downstream components to analyze and extract the information from that corner of the screen and map the extracted values to state keys which indicate the standings of the current race (e.g., which racers are in 1^{st} place, 2^{nd} place, 3^{rd} place, and so forth).

In some instances, the system(s) may generate state keys for an application during application runtime for various purposes. For instance, the system(s) may use the model(s) to analyze screenshots during application runtime and generate state keys for debugging purposes, such as for determining whether all the necessary state keys for an application have been generated and are being used to track state. Additionally, or alternatively, if dynamic changes occur for an application (e.g., new features are added dynamically), the system(s) may be able to account for these changes and still track the state(s) of the added features. In some instances, the system(s) may compare newly generated state keys to an existing set of state keys and determine whether any discrepancies exist, such as missing or extraneous state keys. If discrepancies are detected, the system(s) may flag them for further analysis, allowing developers to refine the state-tracking process and improve the accuracy of application monitoring. Additionally, the system(s) may generate state keys during runtime to accommodate user modifications, such as configurable UI layouts, user-created or AI-generated game modifications, or procedurally generated content, ensuring that the application's state tracking remains up to date without requiring manual reconfiguration. In this way, application-specific virtual assistants may be provided with sufficient context to respond to user queries and/or complete other tasks in a wide range of scenarios.

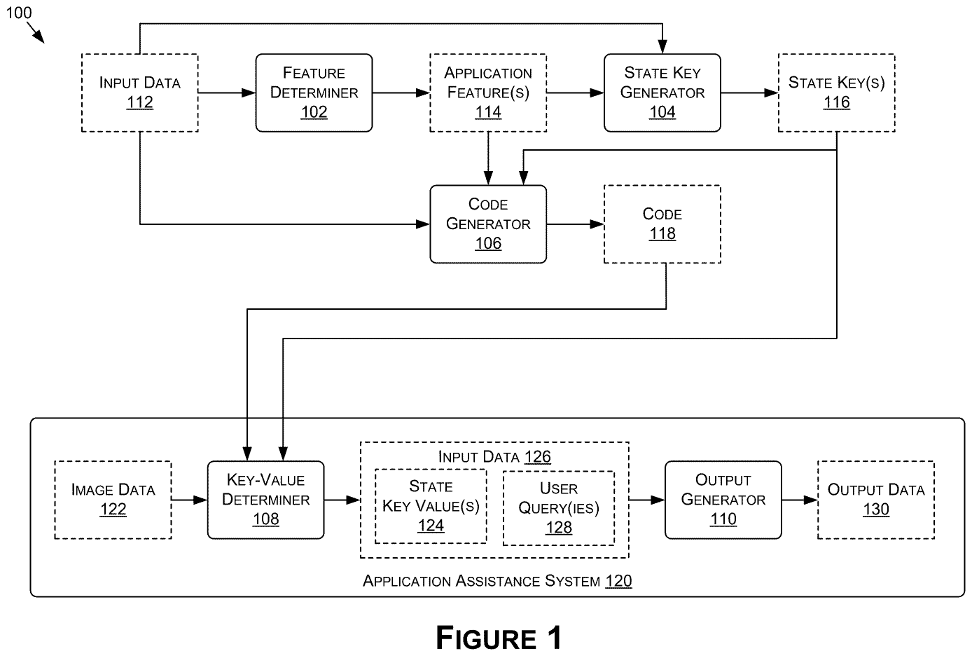

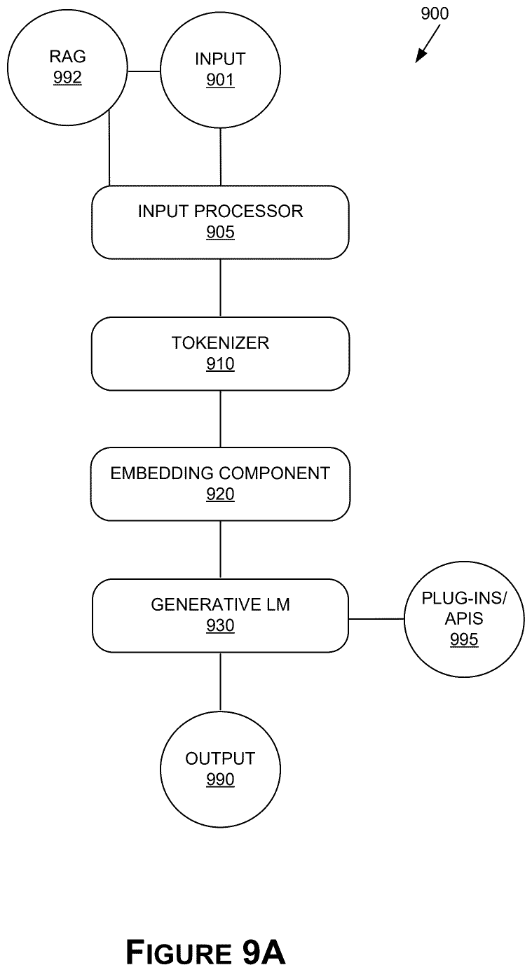

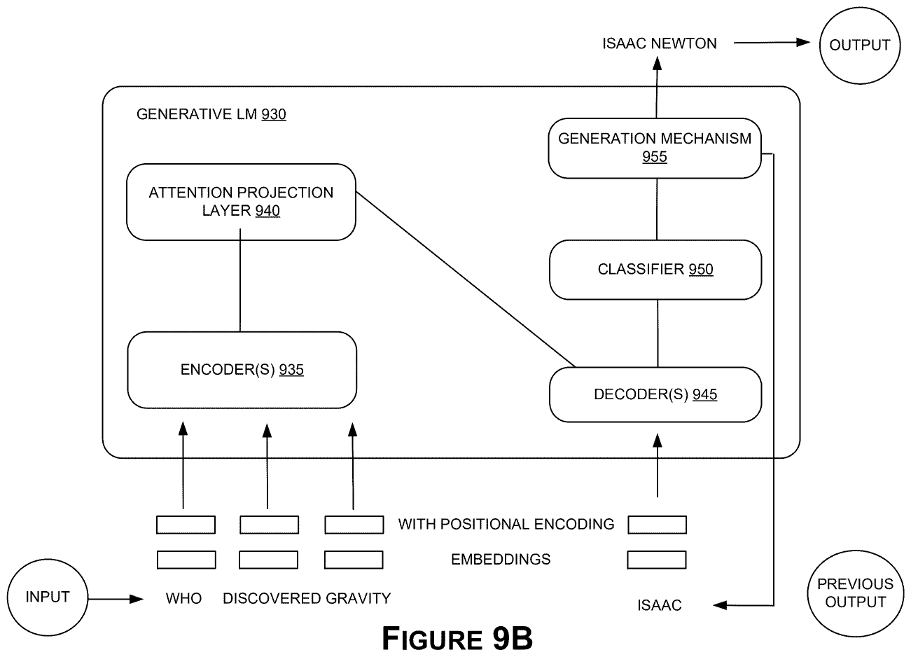

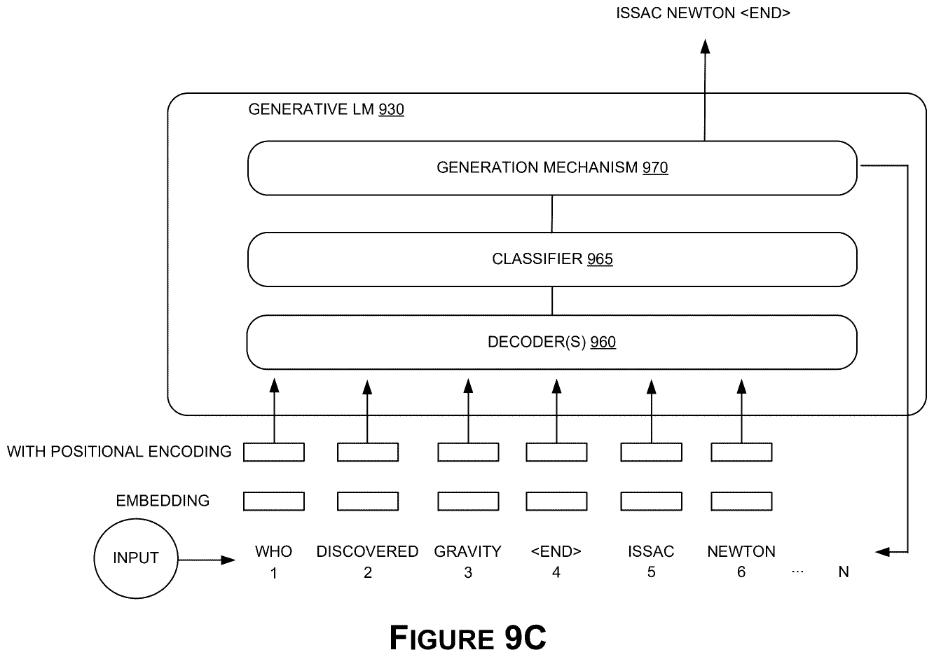

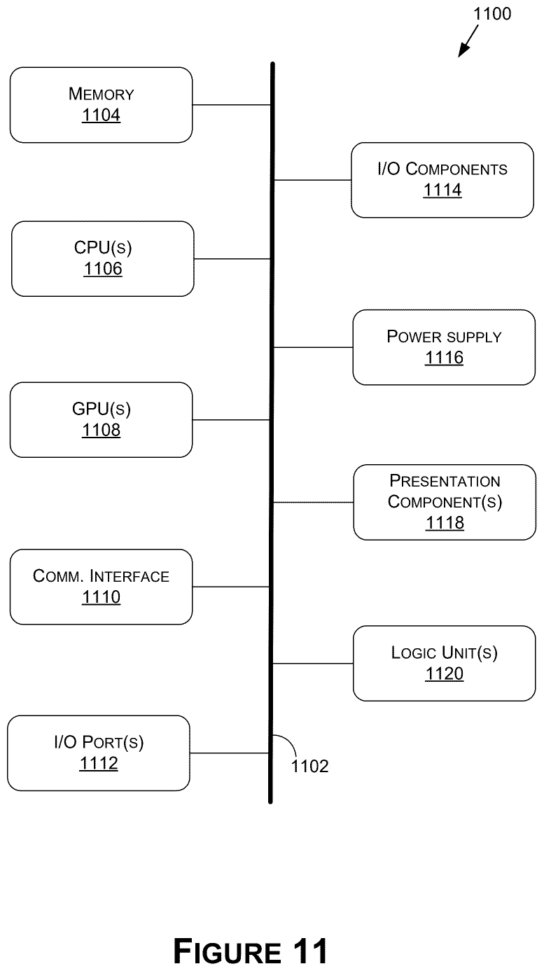

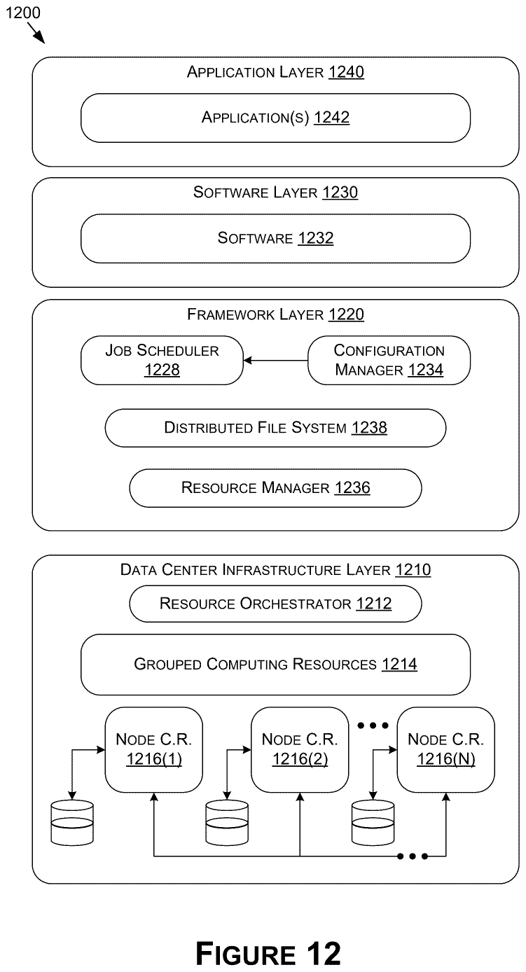

With reference to FIG. 1, FIG. 1 is a data flow diagram illustrating an example of a process 100 for automatically generating and using application state keys for indicating application state, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 9A-9C), one or more computing devices or components thereof (e.g., as described in FIG. 11), and/or one or more data centers or components thereof (e.g., as described in FIG. 12).

As shown, the process 100 may be implemented using, amongst additional or alternative components, a feature determiner 102, a state key generator 104, a code generator 106, a key-value determiner 108, and an output generator 110. In some examples, one or more functionalities of the various components may be implemented using one or more models, such as one or more MMLMs, one or more LLMs, one or more SLMs, one or more VLMs, etc. That is, one or more of the feature determiner 102, the state key generator 104, the code generator 106, the key-value determiner 108, and/or the output generator 110 may include or use the model(s) to perform their respective operations described herein.

As a brief overview, the process 100 may include the feature determiner 102 using the input data 112 to determine one or more application features 114. The state key generator 104 may use the input data 112 and/or the application feature(s) 114 to generate one or more state keys 116 that correspond to the application feature(s) 114. The code generator 106 may use the input data 112, the application feature(s) 114, and/or the state key(s) 116 to generate code 118 (e.g., code for associating value(s) with the state key(s) 116 during application runtime). As shown, in some examples, the code 118 and/or the state key(s) 116 may be provided to an application assistance system 120. For instance, the key-value determiner 108 of the application assistance system 120 may use the state key(s) 116 and/or the code 118 while processing image data 122, and determine one or more state key values 124. That is, the key-value determiner 108 may process the image data 122 (which may represent a screenshot captured during application runtime) and associate or assign the value(s) of the application feature(s) 114 to the state key(s) 116. The state key value(s) 124 may be appended to, or otherwise applied as input data 126 to the output generator 110. The input data 126 may also include one or more user queries 128, and the output generator 110 may process the input data 126 to generate output data 130, which may include or represent responses to the user query (ies) 128. The response may be presented visually or auditorily, depending on system capabilities and/or user preferences.

In some examples, the process 100 may include the feature determiner 102 processing the input data 112 to determine the application feature(s) 114. The input data 112 may include textual prompts, application-related documentation, image data representing screenshots captured during application runtime, and/or other structured or unstructured data sources related to the application (e.g., interactive application) for which the state key(s) 116 are being generated. The feature determiner 102 may analyze this input data 112 using one or more models (e.g., an LLM, SLM, VLM, or MMLM) to extract essential attributes of the application that contribute to its state. The application feature(s) 114 may include, but is/are not limited to, user-related attributes (e.g., player health, inventory status, or active tool selections), environment-related attributes (e.g., weather conditions, time remaining, or scene elements), and/or tool-related attributes (e.g., selected brush in an image editor or active filters in a video editing application). The extracted feature(s) 114 may provide a basis for generating structured state identifiers (keys) that track dynamic application states.

The process 100 also includes the state key generator 104 processing the input data 112 and/or the application feature(s) 114 to generate the state key(s) 116. For instance, the state key generator 104 may apply one or more AI models (e.g., an LLM, a multimodal model, or a retrieval-augmented generation model) to infer a structured set of state keys 116 that correspond to the identified application feature(s) 114. The state key(s) 116 may function as a unique identifier(s) for one or more aspects of the application's state, enabling efficient tracking and mapping of feature values during runtime. In the case of a gaming application, for example, the state key generator 104 may generate state key(s) 116 such as “Player_Health,” “Inventory_Items,” “Active_Quest,” and “Time_Remaining.” For a productivity application, the state key(s) 116 may include “Active_Tool,” “Document_Status,” or “Undo_History.” The state key(s) 116 may be stored in a structured format, such as a dictionary of key-value pairs or any other data structure(s), allowing downstream processes (e.g., the key-value determiner 108) to dynamically populate them with real-time data extracted from application features.

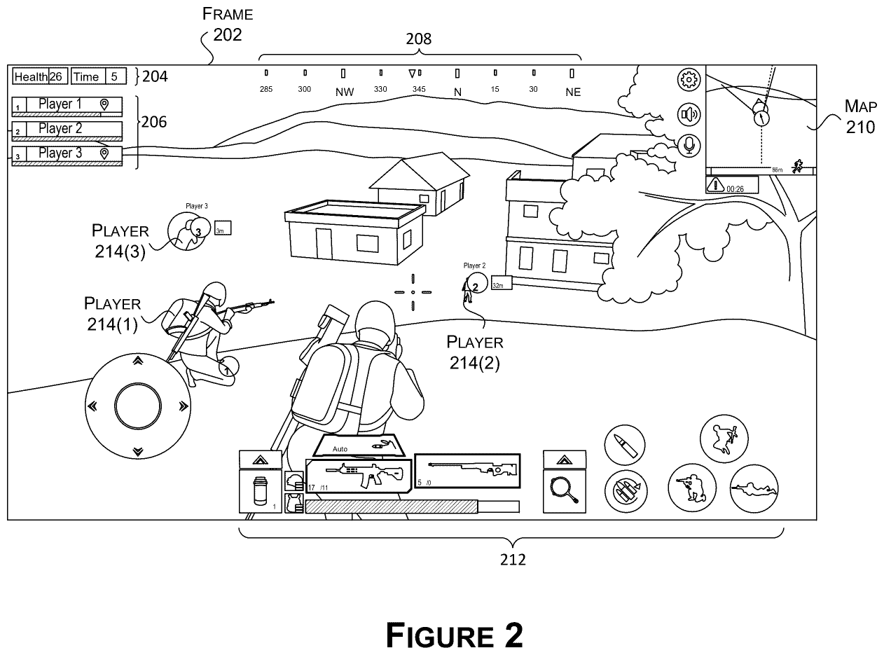

For example, FIG. 2 illustrates an example of application features that may correspond to application state keys generated using the systems and methods of the present disclosure, in accordance with some embodiments of the present disclosure. In the example, of FIG. 2, a frame 202 (e.g., image frame) may correspond to a screenshot captured during runtime of a gaming application. The frame 202 may include text 204 that is associated with a health of the user/main player and a remaining time, such as “Health 26” and “Time 5”, text 206 that is associated with a number of remaining teammates, such as “Player 1”, “Player 2”, and Player 3″, and text 208 (e.g., corresponding to a compass) that is associated with a direction the user/main player is moving, such as “345-degrees”.

The frame 202 may also include a map 210 indicating the user's/main player's current location relative to the virtual environment associated with the gaming application, as well as a plurality of selectable interface elements 212 corresponding to various application inputs or outputs. For instance, the selectable interface elements 212 may be selected by the user to make the main player jump, kneel, or lay prone, to reload, to select weapon(s), to use items from inventory, etc. Additionally, in some examples, the selectable interface elements 212 may indicate various state-related information associated with the application, such as which weapon(s) the user is currently using, actions being performed by the user/main player (e.g., whether the main player is kneeling, jumping, running, laying prone, etc.), items in the user's inventory, etc.

The frame 202 may also depict the virtual environment corresponding to or surrounding the user's/main player's current location in the gaming application. For instance, the frame 202 depicts that the user/main player is at a location in the gaming environment with a number of buildings, a hill, and a tree, as well as relative locations of additional players (e.g., a first player 214(1), a second player 214(2), and a third player 214(3)) or teammates in the gaming environment. The frame 202 may also depict a time of day in the gaming environment (e.g., night time, day time, etc.), environment conditions in the gaming environment (e.g., sunny, rainy, windy, snowy, etc.), or any other features.

In various examples, the feature determiner 102 may analyze the frame 202 (and/or additional frames) to determine the application feature(s) 114. For instance, the feature determiner 102 may determine application feature(s) 114 corresponding to one or more (e.g., each) of the text 204, the text 206, the text 208, the map 210, the selectable interface elements 212, the main player's location, the environmental information associated with the main player's location, the first player 214(1), the second player 214(2), the third player 214(3), or any other features that contribute to the gaming application's state. Additionally, the state key generator 104 may generate state key(s) 116 corresponding to the application feature(s) 114 extracted from the frame 202. For example, based on the text 204 indicating health and remaining time, the state key generator 104 may generate state keys such as “Player_Health” and “Time_Remaining.” Similarly, from the text 206 indicating the number of remaining teammates, state keys such as “Active Teammates” or “Number_Teammates” may be generated. Additionally, the compass direction from the text 208 may be translated into a state key such as “Player_Heading.”

Additionally, the state key generator 104 may generate state keys corresponding to the map 210, such as “Player_Location,” “Map_Coordinates,” or “Map_Status,” which may track the main player's position within the virtual environment of the gaming application. The selectable interface elements 212 may result in state keys such as “Current_Weapon,” “Inventory_Items,” or “Player_Action” (e.g., kneeling, jumping, reloading, etc.). Furthermore, environmental information depicted in the frame 202, such as the time of day or weather conditions, may be associated with state keys like “Game_Time” or “Weather_Condition.” For multiplayer scenarios, the state key generator 104 may also create state keys to track other players' locations and statuses, such as “Teammate_1_Location,” “Teammate_2_Location,” and “Teammate_3_Location,” based on the positions of the first player 214(1), second player 214(2), and third player 214(3).

Referring back to the example of FIG. 1, in various examples described herein, the substance of the input data 112 may vary from one scenario to another based on the information available and/or resources (e.g., models) available. For instance, if the model(s) used by the feature determiner 102 and/or the state key generator 104 are pretrained model(s) with intrinsic knowledge of the application for the which the state key(s) 116 are being generated, then the input data 112 may include a text prompt. That is, the input data 112 may include text data representing a prompt to request the pretrained model(s) to generate a structured list of state keys that correspond to relevant application features. This prompt may be formulated to include high-level descriptions of the application (e.g., “Generate state keys for [name of game], the state keys should track player health, inventory, and quest objectives”) or specific queries about state representation (e.g., “List key attributes that determine gameplay state in [name of game]”). Additionally, or alternatively, in scenarios where the model(s) used by the feature determiner 102 and/or the state key generator 104 are generic or non-pretrained on the specific application, the input data 112 may be more extensive and include a broader range of textual or visual inputs. For example, the input data 112 may include documentation describing the application's mechanics, user interface elements, and key gameplay systems, which the model(s) may analyze to extract relevant features for generating state keys. The input data 112 may also include images, such as screenshots taken during runtime, allowing the model(s) to visually infer important elements of the application state. In these cases, the model(s) may apply computer vision techniques, such as optical character recognition (OCR) and object detection, to extract on-screen elements, recognize their significance, and generate state keys accordingly.

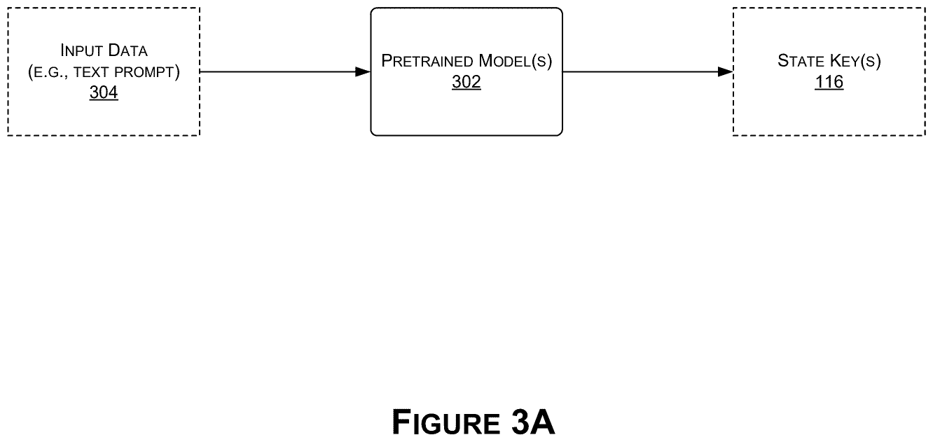

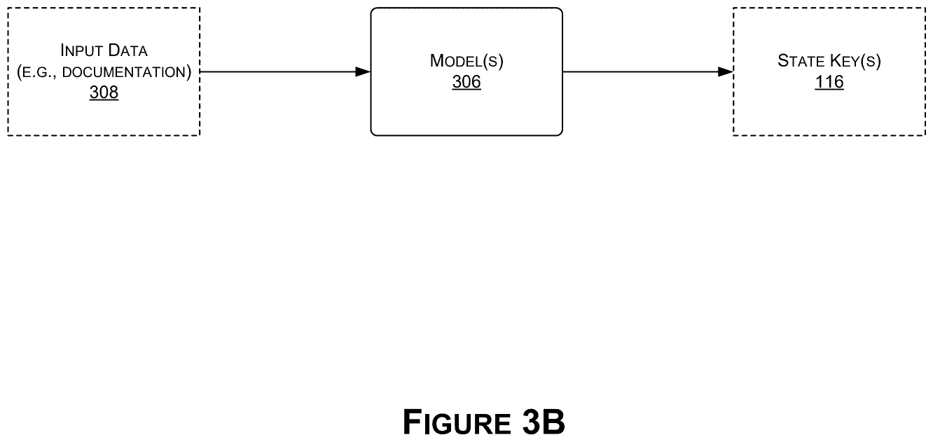

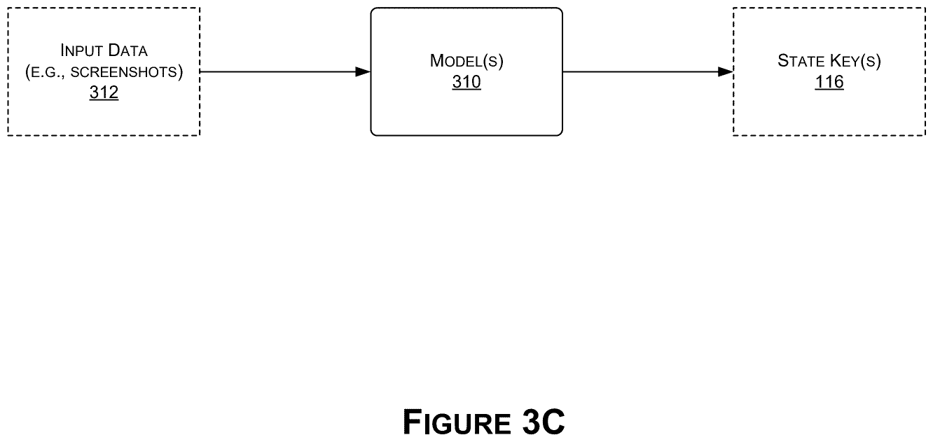

For instance, FIG. 3A illustrates an example of using one or more pretrained models 302 with intrinsic knowledge of an application to automatically generate application state keys, in accordance with some embodiments of the present disclosure. As shown, the pretrained model(s) 302 may generate the state key(s) 116 based at least on processing input data 304, which may include a text prompt. For example, the input data 304 may include a query such as “Generate a list of application state keys for [application name],” prompting the pretrained model(s) 302 to leverage its prior knowledge to output relevant state key(s) 116 for the application. The pretrained model(s) 302 may generate these state key(s) 116 based on its internal understanding of how such applications typically structure state information. In some examples, the pretrained model(s) 302 may correspond to, be included by, or otherwise be used or called by the feature determiner 102 and/or the state key generator 104. For instance, the feature determiner 102 may process the input data 304 using the pretrained model(s) 302 to identify relevant aspects of the application for which state keys should be generated, and the state key generator 104 may use the pretrained model(s) 302 to produce a structured list of the state key(s) 116.

Referring now to FIG. 3B, FIG. 3B illustrates an example of using one or more models 306 (e.g., generic models) to automatically generate application state keys based at least on processing input data 308 that includes information (e.g., documentation, wikis, etc.) associated with an application, in accordance with some embodiments of the present disclosure. As shown, the model(s) 306 may generate the state key(s) 116 based at least on processing the input data 308, which may include or represent documentation related to the application, such as application manuals, wiki pages, or any other sources of application-related information. For instance, the input data 308 may include a game developer's manual outlining character progression mechanics, inventory management, and/or level structures. The model(s) 306 may process this information to identify key terms and relationships, enabling the generation of structured state key(s) 116. Additionally, the model(s) 306 may analyze wiki entries describing core gameplay loops, extracting relevant mechanics (e.g., crafting, exploration, combat) and assigning state keys accordingly. The model(s) 306 may correspond to, be included by, or otherwise be used or called by the feature determiner 102 and/or the state key generator 104. For instance, the feature determiner 102 may use the model(s) 306 to parse the documentation in the input data 308 and/or extract key concepts and contextual information, and the state key generator 104 may use the model(s) 306 to structure this extracted information into the state key(s) 116 for tracking application states.

Now referring to FIG. 3C, FIG. 3C illustrates an example of using one or more models 310 (e.g., generic models) to automatically generate application state keys based at least on processing input data 312 that includes image data associated with an application, in accordance with some embodiments of the present disclosure. As shown, the model(s) 310 may generate the state key(s) 116 based at least on processing the input data 312, which may include one or more screenshots captured during application runtime. For instance, the input data 312 may consist of gameplay screenshots from a strategy game, depicting user interface elements such as resource counters, unit statistics, and/or mission objectives. The model(s) 310 may process these images to detect numerical overlays (e.g., resource values), textual indicators (e.g., “Mission Complete”), and/or spatially relevant elements (e.g., mini maps, health bars, etc.). For instance, the model(s) 310 may use computer vision techniques such as OCR and/or object detection to process the images and generate corresponding state key(s) 116. The model(s) 310 may correspond to, be included by, or otherwise be used or called by the feature determiner 102 and/or the state key generator 104. For instance, the feature determiner 102 may use the model(s) 310 to analyze the image data 312 and/or to identify key visual elements relevant to the application's state, while the state key generator 104 may use the model(s) 310 to map these detected elements to the structured state key(s) 116.

In some examples, the various models described herein-including the pretrained model(s) 302 and the “generic” model(s) 306 and 310—may include one or more language models. However, although many of the examples herein are described with respect to using language models, and, specifically, multimodal language models (MMLMs), this is not intended to be limiting. For example, and without limitation, any of the various model(s) described herein may include any type of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-trained (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian Splat models, models with encoder-only architectures, models with decoder-only architectures, models with encoder-decoder architectures, generative machine learning models, large language models (LLMs), small language models (SLMs), vision language models (VLMs), multimodal language models (MMLMs), including multimodal LLMs and/or multimodal SLMs, and/or any other types of machine learning or generative AI models.

In some examples, the model(s) described herein may be packaged as a microservice—such as an inference microservice (e.g., NVIDIA NIMs)—which may include a container (e.g., an operating system (OS)-level virtualization package) that may include an “engine.” For example, the inference microservice may include the container itself and the model(s) (e.g., weights and biases). In some instances, such as where the model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

In some instances, the model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

Referring back to the example of FIG. 1, the process 100 may, in some examples, include the code generator 106 processing one or more of the input data 112, the application feature(s) 114, and/or the state key(s) 116 to generate the code 118. As described herein, in some instances, the code 118 may include computer-executable instructions configured to facilitate the extraction and mapping of values to the state key(s) 116 during application runtime. For example, in a gaming application, the code 118 may include instructions for analyzing specific bounding regions of a game screen to extract relevant data such as player health, inventory items, and/or active quests using OCR and/or object detection models. Similarly, in a productivity application, the code 118 may include logic for retrieving and updating document status, active tool selections, or recent user actions based on structured API calls. The generated code 118 may be formatted in various programming languages, such as Python or C++, to support integration with a wide variety of game engines, productivity suites, or other interactive applications.

As shown, the state key(s) 116 and/or the code 118 may be provided to the application assistance system 120, which may use this data to determine values for the state key(s) 116 during application runtime. For instance, the key-value determiner 108 of the application assistance system 120 may use the state key(s) 116 and/or the code 118 when processing the image data 122 to determine the state key value(s) 124. In some examples, the key-value determiner 108 may analyze one or more (e.g., a sequence of) runtime screenshots to dynamically extract and update values associated with state key(s) 116. For example, in a gaming environment, the key-value determiner 108 may use OCR to read numerical values from an on-screen health bar and map them to a “Player_Health” state key, or it may use vision models to detect the presence of an enemy and update a value of an “Enemy_Position” state key accordingly. As another example, for a design application, the key-value determiner 108 may identify which tool is currently selected and assign the corresponding value to an “Active_Tool” state key.

In some examples, the state key value(s) 124 may be applied as part of the input data 126 to the output generator 110. The output generator 110 may process the input data 126, which may include the state key value(s) 124 and the user query (ies) 128, and generate the output data 130, which may represent one or more responses to the user query (ies) 128. For example, if a user asks, “What is my current objective?” while playing a game, the output generator 110 may reference the state key value(s) 124 corresponding to “Active_Quest” and return a response such as “Your current quest is ‘Defend the Outpost’ with 5 minutes remaining.” In another example, if a user in an image editing application asks, “What tool am I using?” the output generator 110 may retrieve the value associated with the “Active_Tool” state key and generate a response such as “You are currently using the Brush tool with a size of 12 pixels.” By leveraging the dynamically updated state key value(s) 124, the output generator 110 and/or the application assistance system 120 may provide context-aware responses, improving user engagement and task efficiency.

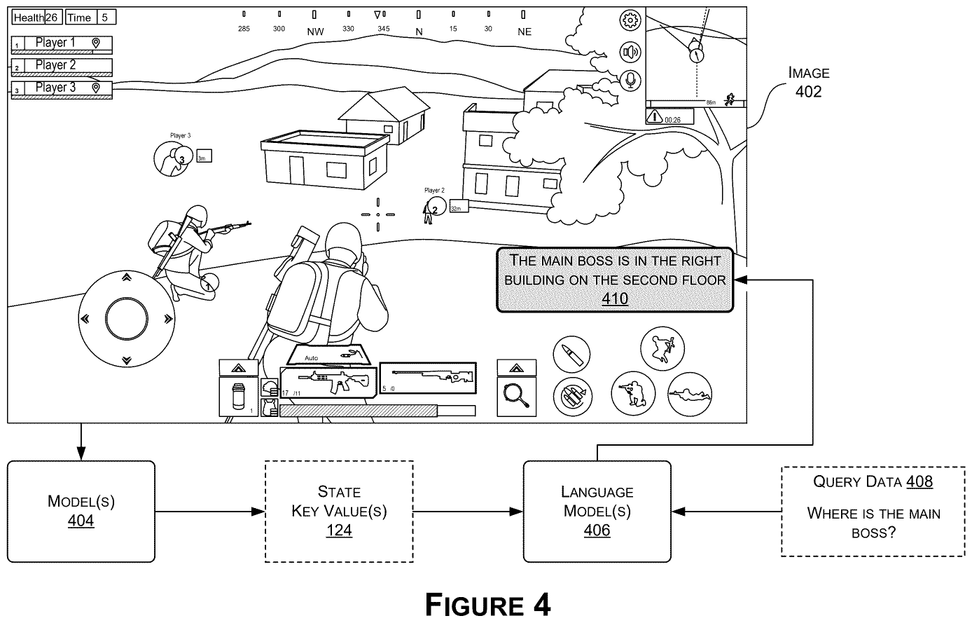

Referring now to FIG. 4, FIG. 4 illustrates an example of using values associated with application state keys to respond to a user query associated with a gaming application, in accordance with some embodiments of the present disclosure. For instance, image data representing an image 402 (e.g., a screenshot captured during application runtime) may be applied to one or more models 404, and the model(s) 404 may determine the state key value(s) 124 representative of the current state of the gaming application. In some examples, the model(s) 404 may correspond to, be included by, or otherwise used or called by the key-value determiner 108 to process the image 402 and output the state key value(s) 124. One or more language model(s) 406 may use the state key value(s) 124 to determine a response 410 to a user query represented by query data 408. For instance, the user query may ask “Where is the main boss?” and the language model(s) 406 may process the state key value(s) 124 to give context to the user query (e.g., by understanding which boss the user might be referring to based on their location in the game) and ultimately generate the response 410, which could say “The main boss is in the right building on the second floor.”

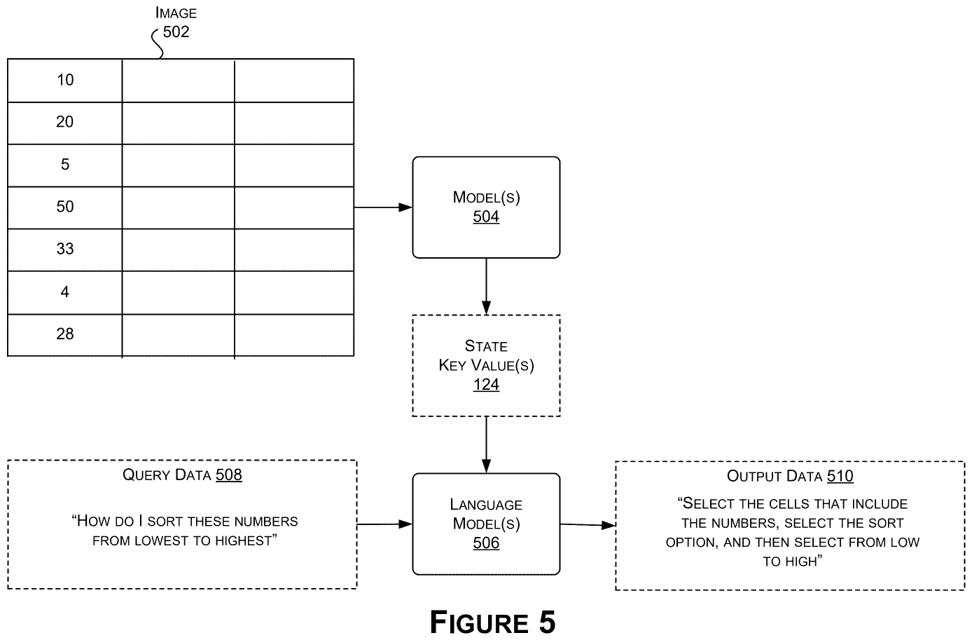

Referring now to FIG. 5, FIG. 5 illustrates another example of using values associated with application state keys to respond to a user query associated with an interactive application, in accordance with some embodiments of the present disclosure. For instance, image data representing an image 502 (e.g., a screenshot captured during application runtime) may be applied to one or more models 504, and the model(s) 504 may determine the state key value(s) 124 representative of the current state of the interactive application. In some examples, the model(s) 504 may correspond to, be included by, or otherwise used or called by the key-value determiner 108 to process the image 502 and output the state key value(s) 124. One or more language model(s) 506 (e.g., which may correspond to, be included by, and/or used or called by the output generator 110) may use the state key value(s) 124 to generate output data 510 representing a response to a user query represented by query data 508. For instance, the user query may ask “How do I sort these numbers from lowest to highest?” and the language model(s) 506 may process the state key value(s) 124 to give context to the user query (e.g., by understanding what numbers the user is referring to, how they might be trying to sort them, etc.) and ultimately generate the response, which could say “Select the cells that include the numbers, select the sort option, and then select from low to high.”

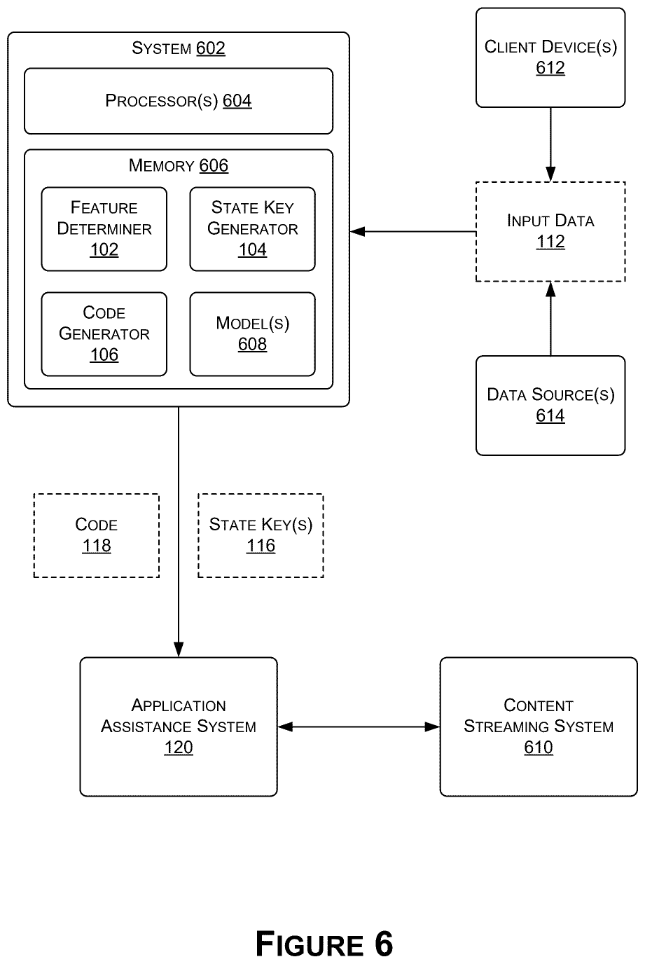

Referring now to FIG. 6, FIG. 6 is a block diagram illustrating an example of a system that may perform one or more of the processes or methods described herein, in accordance with some embodiments of the present disclosure. As shown, the system 602 (which may represent, and/or include, the example computing device(s) 1100 and/or the example data center 1200) may include one or more processors 604 (which may be similar to, and/or include, the CPUs 1106 and/or the GPUs 1108) and memory 606 (which may be similar to, and/or include, the memory 1104). For instance, the memory 606 may store one or more of the feature determiner 102, the state key generator 104, the code generator 106, and/or one or more models 608 (which may correspond to the pretrained model(s) 302, the model(s) 306, the model(s) 310, and/or any other models described herein). Additionally, the processor(s) 604 may execute one or more of the feature determiner 102, the state key generator 104, the code generator 106, and/or the model(s) 608 to perform one or more of the processes described herein.

For instance, the system 602 may obtain or receive the input data 112 from one or more client device(s) 612 and/or one or more data sources 614 (e.g., data source(s) containing application-related documentation, manuals, webpages, wiki sites, videos, images, or any other application-related information). The system 602 may use the processor(s) 604 to execute one or more of the feature determiner 102, the state key generator 104, the code generator 106, and/or the model(s) 608 stored in the memory 606 to generate the state key(s) 116 and/or the code 118, which may be provided to the application assistance system 120. The application assistance system 120 may then use the state key(s) 116 and/or the code 118 to respond to provide users with insight related to one or more applications hosted on the content streaming system 610, which may be streamed to one or more user devices.

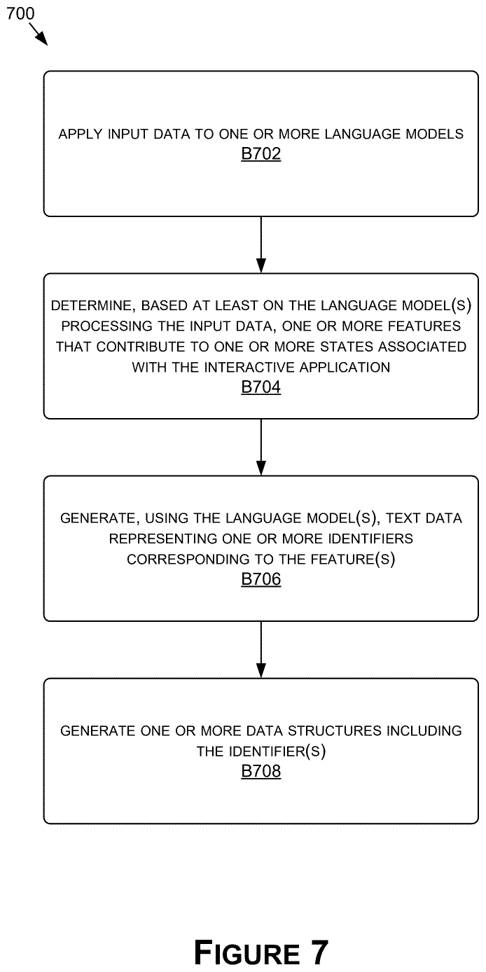

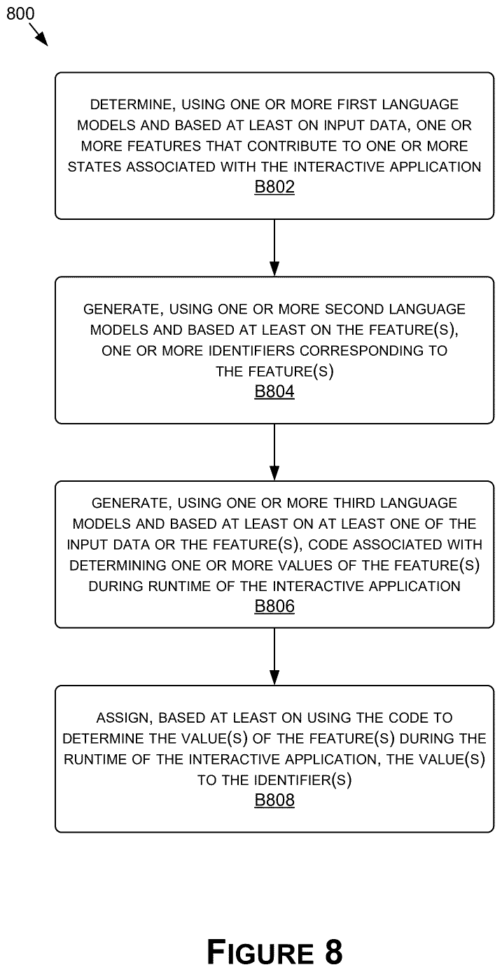

Now referring to FIGS. 7 and 8, each block of methods 700 and 800, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 700 and 800 are described, by way of example, with respect to the system of FIG. 1. However, these methods may additionally or alternatively be executed by any one system, or any combination of systems, including, but not limited to, those described herein.

FIG. 7 is a flow diagram illustrating an example of a method 700 for automatically generating a data structure(s) for tracking application state, in accordance with some embodiments of the present disclosure. The method 700, at block B702, includes applying input data to one or more language models. For instance, the feature determiner 102 and/or the state key generator 104 may apply the input data 112 to the language model(s) (e.g., the model(s) 608). That is, the feature determiner 102 and/or the state key generator 104 may call the language model(s) to process the input data.

The method 700, at block B704, includes determining, based at least on the language model(s) processing the input data, one or more features that contribute to one or more states associated with the interactive application. For instance, the feature determiner 102 may determine the application feature(s) 114 based at least on using the language model(s) to process the input data 112.

The method 700, at block B706, includes generating, using the language model(s), text data representing one or more identifiers corresponding to the feature(s). For instance, the state key generator 104 may use or otherwise call the language model(s) to generate the text data representing the state key(s) 116 that correspond to the application feature(s) 114. In some examples, the language model(s) used by the state key generator 104 may be the same or different as the language model(s) called by the feature determiner 102. Additionally, or alternatively, a single language model may be used to determine the application feature(s) and the state key(s). That is, while shown in FIG. 1 as separate components, in some examples, the feature determiner 102 and the state key generator 104 may correspond to or otherwise represent different processes or operations performed by a single component and/or model.

The method 700, at block B708, includes generating one or more data structures including the identifier(s). For instance, the state key generator 104 and/or another component of the systems described herein may generate the data structure(s) which may include the state key(s) 116. The data structure(s) may comprise a key-value data structure, in some examples, and downstream components or systems (e.g., the application assistance system 120 and/or the components therein) may use the key-value data structure to track state of the application during runtime by associating current values with the state key(s) in the key-value data structure. In some examples, the system(s) may store the data structure(s) in association with the application assistance system 120 and/or the components therein, such as the key-value determiner. For instance, the data structure(s) may be stored in memory accessible to one or more of these systems or components.

FIG. 8 is a flow diagram illustrating an example of a method 800 for mapping values to application state keys generated using the automated, AI-based techniques described herein, in accordance with some embodiments of the present disclosure. The method 800, at block B802, includes determining, using one or more first language models and based at least on input data, one or more features that contribute to one or more states associated with the interactive application. For instance, the feature determiner 102 may use the first language model(s) to process the input data 112 and determine the application feature(s) 114 that contribute to the state(s) of the interactive application.

The method 800, at block B804, includes generating, using one or more second language models and based at least on the feature(s), one or more identifiers corresponding to the feature(s). For example, the state key generator 104 may use the second language model(s) to process the feature(s) (and/or the input data) and generate the identifier(s) corresponding to the feature(s). In some examples, the second language model(s) may be the same as, or different from, the first language model(s).

The method 800, at block B806, includes generating, using one or more third language models and based at least on at least one of the input data or the feature(s), code associated with determining one or more values of the feature(s) during runtime of the interactive application. For instance, the code generator 106 may use the third language model(s) to process the input data 112 and/or the application feature(s) 114 and generate the code 118.

The method 800, at block B808, includes assigning, based at least on using the code to determine the value(s) of the feature(s) during the runtime of the interactive application, the value(s) to the identifier(s). For example, during runtime the key-value determiner 108 of the application assistance system 120 may use the code 118 to determine the state key value(s) 124 corresponding to the application feature(s) 114, and assign these values to the state key(s) 116. IN some examples, the output generator 110 may then use the state key value(s) 124 to determine a current state of the application when responding to the user query (ies) 128 associated with the application.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLM/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models- or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a SLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 930 (e.g., LLM/SLM/VLM/MMLM/etc.). In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 901 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 (which may include one or more RAG models, and/or may be performed using the generative LM 930 itself) may be used to retrieve additional information to be used as part of the input 901 or prompt. RAG may be used to enhance the input to the LLM/SLM/VLM/MMLM/etc. with external knowledge, so that answers to specific questions or queries or requests are more relevant-such as in a case where specific knowledge is required. The RAG component 992 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The RAG component 992 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 992 and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents-which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 992 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data/video data/etc., the input processor 901 may resize the data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features-such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use- or capable of accessing or using-plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer910 of FIG. 9A) into tokens such as words, and each token is encoded (e.g., by the embedding component 920 of FIG. 9A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Content Streaming System

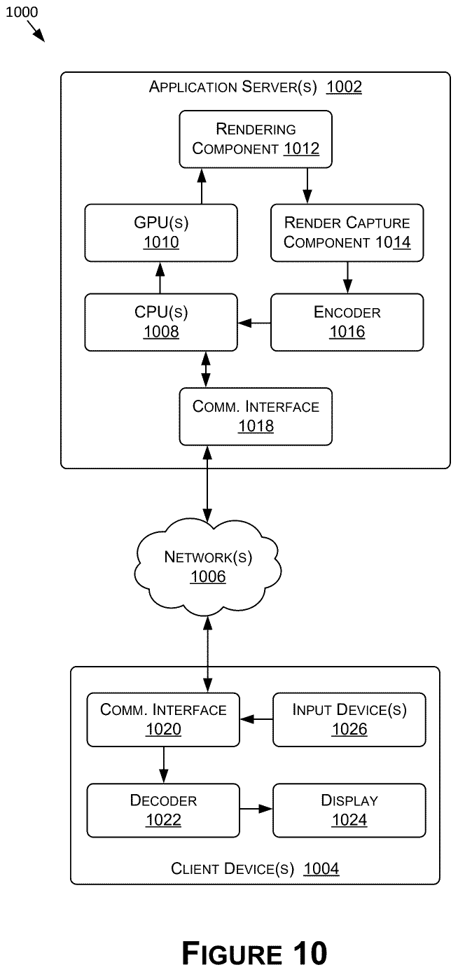

Now referring to FIG. 10, FIG. 10 is an example system diagram for a content streaming system 1000, in accordance with some embodiments of the present disclosure. FIG. 10 includes application server(s) 1002 (which may include similar components, features, and/or functionality to the example computing device 1100 of FIG. 11), client device(s) 1004 (which may include similar components, features, and/or functionality to the example computing device 1100 of FIG. 11), and network(s) 1006 (which may be similar to the network(s) described herein). In some embodiments of the present disclosure, the system 1000 may be implemented. The application session may correspond to a game streaming application (e.g., NVIDIA GeForce NOW), a remote desktop application, a simulation application (e.g., autonomous or semi-autonomous vehicle simulation), computer aided design (CAD) applications, virtual reality (VR), augmented reality (AR), and/or mixed reality (MR) streaming applications, deep learning applications, and/or other application types.

In the system 1000, for an application session, the client device(s) 1004 may only receive input data in response to inputs to the input device(s), transmit the input data to the application server(s) 1002, receive encoded display data from the application server(s) 1002, and display the display data on the display 1024. As such, the more computationally intense computing and processing is offloaded to the application server(s) 1002 (e.g., rendering—in particular ray or path tracing—for graphical output of the application session is executed by the GPU(s) of the game server(s) 1002). In other words, the application session is streamed to the client device(s) 1004 from the application server(s) 1002, thereby reducing the requirements of the client device(s) 1004 for graphics processing and rendering.

For example, with respect to an instantiation of an application session, a client device 1004 may be displaying a frame of the application session on the display 1024 based on receiving the display data from the application server(s) 1002. The client device 1004 may receive an input to one of the input device(s) and generate input data in response. The client device 1004 may transmit the input data to the application server(s) 1002 via the communication interface 1020 and over the network(s) 1006 (e.g., the Internet), and the application server(s) 1002 may receive the input data via the communication interface 1018. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1012 may render the application session (e.g., representative of the result of the input data) and the render capture component 1014 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 1002. In some embodiments, one or more virtual machines (VMs)—e.g., including one or more virtual components, such as vGPUs, vCPUs, etc.—may be used by the application server(s) 1002 to support the application sessions. The encoder 1016 may then encode the display data to generate encoded display data and the encoded display data may be transmitted to the client device 1004 over the network(s) 1006 via the communication interface 1018. The client device 1004 may receive the encoded display data via the communication interface 1020 and the decoder 1022 may decode the encoded display data to generate the display data. The client device 1004 may then display the display data via the display 1024.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161 (N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may use distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216 (N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: applying input data to one or more language models; determining, based at least on the one or more language models processing the input data, one or more features of an interactive application that contribute to one or more states associated with the interactive application; generating, using the one or more language models, text data representing one or more identifiers corresponding to the one or more features; and storing one or more data structures including the one or more identifiers corresponding to the one or more features, wherein, during runtime of the interactive application, one or more values associated with the one or more features are mapped to the one or more identifiers of the one or more data structures to indicate the one or more states associated with the interactive application.

B. The method of paragraph A, wherein the interactive application is a gaming application and the one or more features correspond to one or more on-screen elements indicative of the one or more states associated with the gaming application.

C. The method of any one of paragraphs A-B, wherein the input data includes at least one of: second text data representing information related to the interactive application; or image data representing a plurality of images depicting a plurality of screenshots captured during the runtime of the interactive application.

D. The method of any one of paragraphs A-C, wherein the one or more language models are pretrained with respect to the one or more features of the interactive application, and the input data includes second text data representing one or more input prompts to the one or more language models, the one or more input prompts associated with requesting the one or more language models to generate the one or more identifiers.

E. The method of any one of paragraphs A-D, further comprising: determining, based at least on the one or more language models processing the input data, one or more locations of one or more bounding regions with respect to one or more images rendered during runtime of the interactive application, wherein the one or more values are determined based at least on analyzing image data included within the one or more bounding regions.

F. The method of any one of paragraphs A-E, further comprising: generating, using one or more generative artificial intelligence (AI) models, second text data representing one or more computer-executable instructions, wherein the computer-executable instructions, when executed, cause one or more computing devices to map, based at least on analyzing one or more images captured during runtime of the interactive application, the one or more values to the one or more identifiers.

G. The method of any one of paragraphs A-F, wherein the analyzing of the one or more images comprises analyzing, using one or more optical character recognition (OCR) models, at least textual information depicted in one or more bounding regions of the one or more images to determine the one or more values.

H. A system comprising: one or more processors to: determine, based at least on mapping one or more values to one or more identifiers during runtime of an interactive application, one or more states associated with the interactive application, wherein the one or more identifiers are generated, at least, by: determining, using one or more language models and based at least on input data, one or more features of the interactive application that contribute to the one or more states; and updating, using the one or more language models, one or more data structures with the one or more identifiers corresponding to the one or more features.

I. The system of paragraph H, wherein the one or more language models include at least one of: one or more multimodal language models; one or more large language models; one or more small language models; or one or more vision language models.

J. The system of any one of paragraphs H-I, wherein the interactive application is a gaming application and the one or more features correspond to one or more on-screen elements indicative of the one or more states associated with the gaming application.

K. The system of any one of paragraphs H-J, wherein the input data includes at least one of text data or image data corresponding to at least one of one or more manuals, one or more wiki pages, or one or more documents including information associated with the interactive application.

L. The system of any one of paragraphs H-K, wherein the input data includes, at least, image data representing one or more images depicting one or more screenshots captured during the runtime of the interactive application.

M. The system of any one of paragraphs H-L, wherein the one or more language models are pretrained with respect to the interactive application, and the input data includes text data representing one or more input prompts to the one or more language models, the one or more input prompts associated with requesting the one or more language models to update the one or more data structures.

N. The system of any one of paragraphs H-M, the one or more processors further to determine, using one or more vision models to analyze image data within one or more bounding regions within one or more images generated during the runtime of the interactive application, the one or more values to map to the one or more identifiers.

O. The system of any one of paragraphs H-N, wherein the determination of the one or more values is based at least on the one or more processors executing one or more computer-executable instructions that cause the one or more processors to analyze the image data within the one or more bounding regions, and wherein the computer-executable instructions are generated, at least, by: generating, using one or more second language models and based at least on one or more features, text data representing the one or more computer-executable instructions.

P. The system of any one of paragraphs H-O, the one or more processors further to: analyze, using one or more optical character recognition (OCR) models, textual information depicted in one or more screenshots captured during the runtime of the interactive application; and determine, based at least on the analyzation of the textual information, the one or more values to map to the one or more identifiers.

Q. The system of any one of paragraphs H-P, wherein the system is comprised in at least one of: a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multimodal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

R. One or more processors comprising: processing circuitry to update, using one or more multimodal language models and based at least on input data including at least one of first text data representing one or more input prompts, second text data representing information associated with an interactive application, or image data representing one or more screenshots captured during runtime of the interactive application, one or more data structures with one or more state identifiers corresponding to one or more features of the interactive application that contribute to one or more states associated with the interactive application.

S. The one or more processors of paragraph R, the processing circuitry further to determine, using the one or more multimodal language models and based at least on the input data, the one or more features that contribute to the one or more states, wherein the update of the one or more data structures is further based at least on the determination of the one or more features.

T. The one or more processors of any one of paragraphs R-S, wherein the one or more processors are comprised in at least one of: a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multimodal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

What is claimed is:

1. A method comprising:
applying input data to one or more language models;
determining, based at least on the one or more language models processing the input data, one or more features of an interactive application that contribute to one or more states associated with the interactive application;
generating, using the one or more language models, text data representing one or more identifiers corresponding to the one or more features; and
storing one or more data structures including the one or more identifiers corresponding to the one or more features,
wherein, during runtime of the interactive application, one or more values associated with the one or more features are mapped to the one or more identifiers of the one or more data structures to indicate the one or more states associated with the interactive application.

2. The method of claim 1, wherein the interactive application is a gaming application and the one or more features correspond to one or more on-screen elements indicative of the one or more states associated with the gaming application.

3. The method of claim 1, wherein the input data includes at least one of:
second text data representing information related to the interactive application; or
image data representing a plurality of images depicting a plurality of screenshots captured during the runtime of the interactive application.

4. The method of claim 1, wherein:
the one or more language models are pretrained with respect to the one or more features of the interactive application, and
the input data includes second text data representing one or more input prompts to the one or more language models, the one or more input prompts associated with requesting the one or more language models to generate the one or more identifiers.

5. The method of claim 1, further comprising:
determining, based at least on the one or more language models processing the input data, one or more locations of one or more bounding regions with respect to one or more images rendered during runtime of the interactive application,
wherein the one or more values are determined based at least on analyzing image data included within the one or more bounding regions.

6. The method of claim 1, further comprising:
generating, using one or more generative artificial intelligence (AI) models, second text data representing one or more computer-executable instructions,
wherein the computer-executable instructions, when executed, cause one or more computing devices to map, based at least on analyzing one or more images captured during runtime of the interactive application, the one or more values to the one or more identifiers.

7. The method of claim 6, wherein the analyzing of the one or more images comprises analyzing, using one or more optical character recognition (OCR) models, at least textual information depicted in one or more bounding regions of the one or more images to determine the one or more values.

8. A system comprising:
one or more processors to:
determine, based at least on mapping one or more values to one or more identifiers during runtime of an interactive application, one or more states associated with the interactive application, wherein the one or more identifiers are generated, at least, by:
determining, using one or more language models and based at least on input data, one or more features of the interactive application that contribute to the one or more states; and
updating, using the one or more language models, one or more data structures with the one or more identifiers corresponding to the one or more features.

9. The system of claim 8, wherein the one or more language models include at least one of:
one or more multimodal language models;
one or more large language models;
one or more small language models; or
one or more vision language models.

10. The system of claim 8, wherein the interactive application is a gaming application and the one or more features correspond to one or more on-screen elements indicative of the one or more states associated with the gaming application.

11. The system of claim 8, wherein the input data includes at least one of text data or image data corresponding to at least one of one or more manuals, one or more wiki pages, or one or more documents including information associated with the interactive application.

12. The system of claim 8, wherein the input data includes, at least, image data representing one or more images depicting one or more screenshots captured during the runtime of the interactive application.

13. The system of claim 8, wherein:
the one or more language models are pretrained with respect to the interactive application, and
the input data includes text data representing one or more input prompts to the one or more language models, the one or more input prompts associated with requesting the one or more language models to update the one or more data structures.

14. The system of claim 8, the one or more processors further to determine, using one or vision models to analyze image data within one or more bounding regions within one or more images generated during the runtime of the interactive application, the one or more values to map to the one or more identifiers.

15. The system of claim 14, wherein the determination of the one or more values is based at least on the one or more processors executing one or more computer-executable instructions that cause the one or more processors to analyze the image data within the one or more bounding regions, and wherein the computer-executable instructions are generated, at least, by:
generating, using one or more second language models and based at least on one or more features, text data representing the one or more computer-executable instructions.

16. The system of claim 8, the one or more processors further to:
analyze, using one or more optical character recognition (OCR) models, textual information depicted in one or more screenshots captured during the runtime of the interactive application; and
determine, based at least on the analyzation of the textual information, the one or more values to map to the one or more identifiers.

17. The system of claim 8, wherein the system is comprised in at least one of:
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multimodal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

18. One or more processors comprising:
processing circuitry to update, using one or more multimodal language models and based at least on input data including at least one of first text data representing one or more input prompts, second text data representing information associated with an interactive application, or image data representing one or more screenshots captured during runtime of the interactive application, one or more data structures with one or more state identifiers corresponding to one or more features of the interactive application that contribute to one or more states associated with the interactive application.

19. The one or more processors of claim 18, the processing circuitry further to:
determine, using the one or more multimodal language models and based at least on the input data, the one or more features that contribute to the one or more states,
wherein the update of the one or more data structures is further based at least on the determination of the one or more features.

20. The one or more processors of claim 18, wherein the one or more processors are comprised in at least one of:
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multimodal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
